(19) United States
(12) Patent Application Publication
(10) Pub. No.: US 2012/0324148 A1
(43) Pub. Date: Dec. 20, 2012

(54) SYSTEM AND METHOD OF PROTECTING METADATA FROM NAND FLASH FAILURES

(76) Inventors: Paul Roger Stonelake, Santa Clara, CA (US); Douglas Alan Prins, Laguna Hills, CA (US); Anand Krisnamurthi Kulkarni, San Jose, CA (US)

(21) Appl. No.: 13/286,012

(22) Filed: Oct. 31, 2011

Related U.S. Application Data
(60) Provisional application No. 61/498,594, filed on Jun. 19, 2011.

(51) Int. Cl. G06F 12/00

(52) U.S. Cl. 711/103; 711/E12.008

(57) ABSTRACT

Methods and systems are disclosed for protecting metadata from NAND flash failures. With data striped across multiple flash memory chips, the flash memory multiple chips may store multiple copies of metadata (and potentially ECC). The metadata stored in the multiple copies on the flash memory chips may be different from one another. For example, on a particular chip, a first copy of metadata is stored and a second copy of metadata is stored, with the second copy being a redundant copy of the metadata stored on a different chip. In this way, if one of the chips fails, a copy of the failed chips metadata is stored on another of the chips, and may be accessed.

### REFERENCE TO RELATED APPLICATION

This application claims the benefit of U.S. Provisional Application No. 61/498,594, filed Jun. 19, 2011, the entirety of U.S. Provisional Application No. 61/498,594 is hereby incorporated by reference herein.

### TECHNICAL FIELD

This application relates generally to managing data in a memory system. More specifically, this application relates to protecting metadata from NAND flash failures.

### BACKGROUND

Data written to NAND flash pages is typically broken into user data (protected by error correction coding (ECC)) and metadata (also protected by ECC). The metadata describes what user data is stored on the flash page, and having valid metadata for all flash pages is essential to rebuilding the correct logical-to-physical page mapping. For example, the metadata typically contains the logical block addresses (LBAs) of the user data and the relative age of these LBAs.

For architectures that stripe data across two or more NAND pages, a single logical page might contain 8 kB or more of user data and much smaller amount of metadata, which might consume up to 32 bytes of metadata per logical NAND page (striped across two or more physical NAND pages).

When the data is striped across two or more physical NAND devices (such as across two different flash memory chips), and one of the NAND devices fails, this failure may exceed the ECC capability of the controller and typically affects both user data and metadata. One solution to the problem of NAND failure is more robust ECC, thereby ensuring that many bit errors can be corrected (such as 12 bits of ECC correction per 32 bytes of metadata). Even still, a failure of a single NAND device may prove that improved ECC is deficient if 13 bits or more are incorrect. Another solution is maintaining redundant copies of metadata. For example, two copies of the metadata may be maintained to increase chances that at least one copy is correctable. However, this solution is deficient if one of the two or more physical NAND pages has a very high error rate, thereby resulting in both copies of the metadata potentially being uncorrectable.

### SUMMARY

In order to address the problem of flash memory devices failing, methods and systems are disclosed herein for protecting metadata from flash memory failures.

According to a first aspect, a method of storing redundant copies of metadata in order to protect the metadata from flash memory device failures is disclosed. The method includes, in a flash memory device with a controller and first and second flash memory partitions, user data being stored across the first and second flash memory partitions and metadata corresponding to the user data, the metadata including at least a first part and a second part: storing in the first flash memory partition a first copy of the first part of the metadata; storing in the second flash memory partition a first copy of the second part of the metadata; and storing in the first flash memory partition a second copy of the second part of the metadata. So that, multiple copies of the flash memory metadata are stored in different flash memory chips. In this way, if one or more of the memory chips fail, the metadata may still be recovered since the additional copies of the metadata are stored on the different flash memory chips.

In another aspect, a method of storing redundant copies of metadata in order to protect the metadata from flash memory device failures is disclosed. The method includes, in a flash memory device with a controller and first and second flash memory partitions, user data being stored across the first and second flash memory partitions and metadata corresponding to the user data, the metadata including at least a first part and a second part: storing in the first flash memory partition a first copy of the first part of the metadata; storing in the second flash memory partition a first copy of the second part of the metadata; and storing in the first flash memory partition a second copy of at least some of the second part of the metadata. In this way, the multiple copies of the flash memory metadata are not identical. For example, the second copies of the flash memory chip metadata may be less than the first copies of the flash memory chip metadata, the second copies being sufficient for reconstruction with error correction coding. In operation, the first copies of the flash memory metadata may be examined to determine whether they are correctable (such as correctable using error correction coding). If the first copies of the flash memory metadata are not correctable, it is assumed that one or more of the flash memory chips are faulty, and one or more of the second copies of the flash memory metadata on the memory chips assumed not to be faulty is used.

In another aspect, a memory device is disclosed. The memory device is configured to store redundant copies of metadata in order to protect the metadata from memory device failures, the metadata corresponding to the user data and including at least a first part and a second part. The memory device comprises: a memory including a first flash memory partition and a second flash memory partition; and a controller in communication with the memory. The controller is configured to: store user data across the first and second flash memory partitions; store in the first flash memory partition a first copy of the first part of the metadata; store in the second flash memory partition a first copy of the second part of the metadata; and store in the first flash memory partition a second copy of the second part of the metadata. Thus, the controller is configured to store multiple copies of the flash memory metadata in different flash memory chips. In this way, if one or more of the memory chips fail, the controller may still recover the metadata since the additional copies of the metadata are stored on the different flash memory chips.

In yet another aspect, a memory device is disclosed. The memory device is configured to store redundant copies of metadata in order to protect the metadata from memory device failures, the metadata corresponding to the user data and including at least a first part and a second part. The memory device comprises: a memory including a first flash memory partition and a second flash memory partition; and a controller in communication with the memory. The controller is configured to: store user data across the first and second flash memory partitions; store in the first flash memory partition a first copy of the first part of the metadata; store in the second flash memory partition a first copy of the second part of the metadata; and store in the first flash memory partition a second copy of at least some of the second part of the metadata.

Other features and advantages will become apparent upon review of the following drawings, detailed description and claims. Additionally, other embodiments are disclosed, and each of the embodiments can be used alone or together in combination. The embodiments will now be described with reference to the attached drawings.

### BRIEF DESCRIPTION OF THE DRAWINGS

FIG. 1 illustrates a host connected with a memory device having a multi-bank non-volatile memory containing multiple die.

FIG. 2 illustrates an example of physical memory organization of the system in FIG. 1.

FIG. 3 illustrates a prior art listing of the copies for metadata striped over two chips.

FIG. 4 illustrates one example listing of the copies for metadata striped over two chips, with the copies being different in at least one aspect and with the sequence of recovery illustrated if one of the chips fails.

FIG. 5 illustrates another example listing of the copies for metadata striped over two chips, with the copies being different in at least one aspect and with the sequence of recovery illustrated if one of the chips fails.

FIG. 6 illustrates yet another example listing of the copies for metadata striped over two chips, with the copies being different in at least one aspect and with the sequence of recovery illustrated if one of the chips fails.

FIG. 7 illustrates an example listing of the copies for metadata striped over four chips, with the copies being different in at least one aspect and with the sequence of recovery illustrated if one of the chips fails.

FIG. 8 illustrates a more detailed example of data and metadata organization within a block of the memory device shown in FIG. 2.

FIG. 9 is a flow chart illustrating the steps by which to check the various copies of the metadata.

### DETAILED DESCRIPTION

As discussed in the background, a flash memory device relies on metadata for access to user data stored on the flash memory device. In one embodiment, a method and system is disclosed that protect metadata from flash memory device failures.

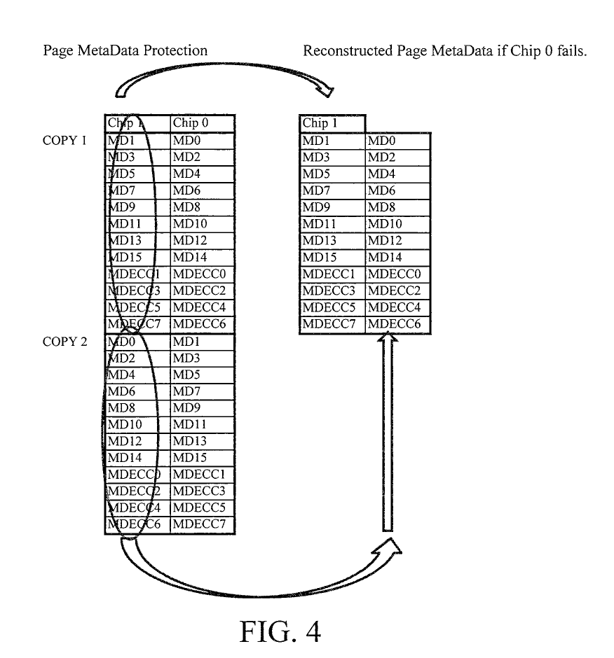

Flash memory in the flash memory device may be partitioned in various ways. One way to partition the flash memory is across multiple flash memory chips in which user data is stored across the multiple flash memory chips. Similarly, metadata may be stored across the multiple flash memory chips. Examples of the metadata being stored across multiple flash memory chips are illustrated in FIGS. 4-6. Further, as discussed in more detail below, metadata and error correction data (such as ECC data), the combination of which is termed ECC protected metadata, may be stored across the multiple flash memory chips.

The metadata may be divided across the multiple chips in a variety of ways. One way is to divide the metadata across the multiple chips in a predetermined sequence. For example, FIG. 4 illustrates that the metadata is separated so that even bytes of metadata are stored in one chip and odd bytes of data are stored in another chip.

One, some, or all of the flash memory partitions (such as one, some or all of the flash memory chips) may store multiple copies of the metadata. Further, the multiple copies of the metadata stored on a particular partition may be different from each other in at least one aspect. In one aspect, at least a part of the metadata stored in the first copy of one flash memory chip may be stored in the second copy of the metadata in another flash memory chip.

In one embodiment, the second copy of the metadata stored on one of the multiple chips may be identical to the first copy of the metadata stored on a different one of the multiple chips. As discussed in more detail below, FIG. 4 illustrates COPY 1 of the metadata stored on Chip 0 and Chip 1 and COPY 2 of the metadata stored on Chip 0 and Chip 1. As shown in FIG. 4, COPY 2 stored on Chip 0 differs from COPY 1 stored on Chip 0. Likewise, COPY 2 stored on Chip 1 differs from COPY 1 stored on Chip 1. FIG. 4 shows that COPY 2 stored on Chip 0 is identical to COPY 1 stored on Chip 1. Likewise, COPY 2 stored on Chip 1 is identical to COPY 1 stored on Chip 0. In this way, if one of the chips is faulty, COPY 2 may be used.

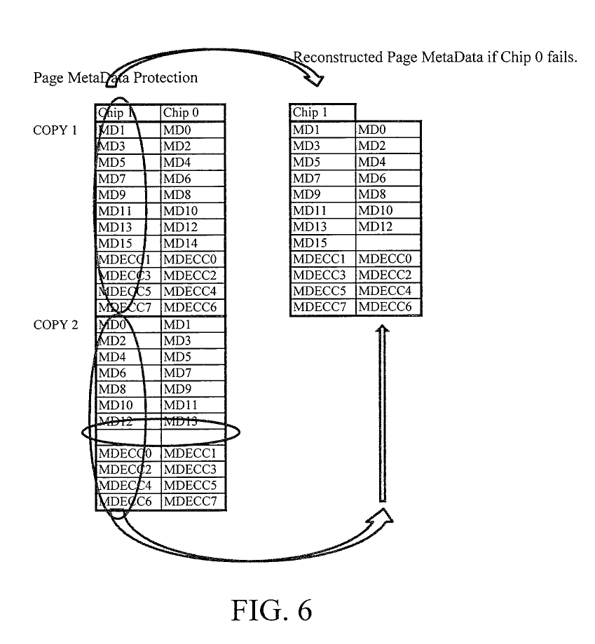

In an alternate embodiment, the second copy stored on one of the multiple chips may store some, but less than all, of the metadata stored on the first copy in a different one of the multiple chips. For example, FIG. 6 illustrates COPY 1 of the metadata stored on Chip 0 and Chip 1 and COPY 2 of the metadata stored on Chip 0 and Chip 1. As shown in FIG. 6, COPY 2 stored on Chip 0 differs from COPY 1 stored on Chip 0. Likewise, COPY 2 stored on Chip 1 differs from COPY 1 stored on Chip 1. Further, as shown in FIG. 6, COPY 2 stored on Chip 0 stores some, but not all, of the metadata stored in COPY 1 stored on Chip 1. In particular, COPY 2 stored on Chip 0 does not store MD15. Likewise, COPY 2 stored on Chip 1 stores some, but not all, of the metadata stored in COPY 1 stored on Chip 0. In particular, COPY 2 stored on Chip 0 does not store MD14. FIG. 6 is for illustration purposes to indicate that some of the metadata (such as, for example, MD14) is not stored. Alternatively, other parts of the metadata, such as error correction for the metadata (such as MDECC0-MDECC7) may likewise not be stored in COPY 2.

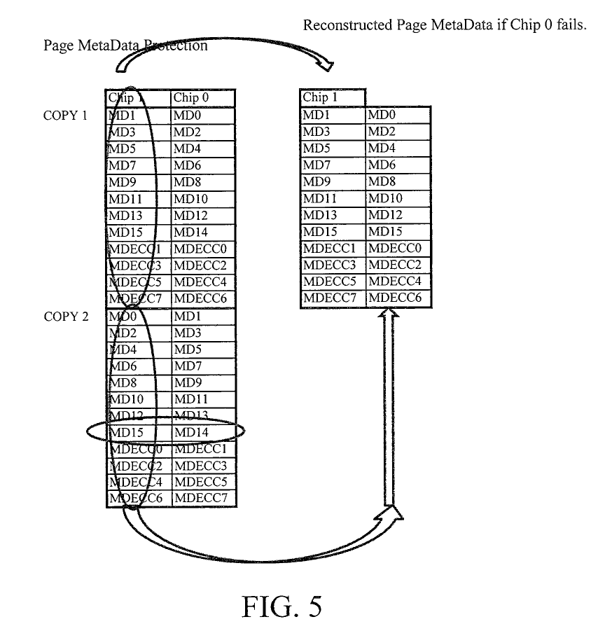

In still an alternate embodiment, the second copy stored on one of the multiple chips may store a combination of metadata from different chips. For example, FIG. 5 illustrates COPY 1 of the metadata stored on Chip 0 and Chip 1 and COPY 2 of the metadata stored on Chip 0 and Chip 1. As shown in FIG. 5, COPY 2 stored on Chip 0 differs from COPY 1 stored on Chip 0. Likewise, COPY 2 stored on Chip 1 differs from COPY 1 stored on Chip 1. Further, as shown in FIG. 5, COPY 2 stored on Chip 0 stores a combination of the metadata from COPY 1 on both Chip 0 and Chip 1. In particular, COPY 2 stores at least a part of COPY 1 from both Chip 0 and from Chip 1. Likewise, COPY 2 stored on Chip 1 stores a combination of the metadata stored in COPY 1 on Chip 0 and on Chip 1. FIG. 5 is for illustration purposes to indicate that the second copy of the metadata stored on a flash memory chip may be a combination of the first copy stored on multiple flash memory chips.

In accessing the metadata, the methodology may first assume that none of the flash memory chips is faulty, and use the metadata stored in each of the respective chips. If it is determined that this assumption is incorrect (e.g., ECC determines that the assumption is incorrect), the methodology may then assume that one (or two, or more) of the flash memory chips may be faulty. The fault may be due to a complete failure of one or more NAND chips. Or, the fault may be due to a local corruption of the first copy of the metadata. Regardless, the methodology may proceed through a series of assumptions as to the fault of various flash memory chips, and access backup copies of the flash memory chips assumed to be faulty. The backup copies (along with other copies) may be analyzed with ECC to determine if the assumption is correct.

For example, in a two-chip example (Chip 0 and Chip 1) the metadata may be divided and stored in both Chip 0 and in Chip 1, in which Chip 0 includes a first copy of ½ of the metadata and a second copy of the other ½ of the metadata. Likewise, Chip 1 includes a first copy of the other ½ of the metadata and a second copy of the first ½ of the metadata. Initially, it is assumed that Chip 0 and Chip 1 are functioning properly, so that first copy in each of Chip 0 (containing the first ½ of the metadata) and Chip 1 (containing the other ½ of the metadata) is accessed. Using ECC, the first copy in each of Chip 0 and Chip 1 is checked. If FCC indicates that the data is uncorrectable, it may be assumed that one of Chip 0 or Chip 1 is faulty. After which, the methodology assumes that Chip 0 is faulty (and Chip 1 is functioning), and then accesses in Chip 1 the first copy of the other ½ of the metadata and the second copy of the first ½ of the metadata. FCC is again used to determine if the metadata accessed is uncorrectable. If it is uncorrectable, the methodology assumes that Chip 1 is faulty (and Chip 0 is functioning), and then accesses in Chip 0 the first copy of the first ½ of the metadata and the second copy of the other ½ of the metadata. ECC is again used to determine if the metadata accessed is uncorrectable. If it is still uncorrectable, the methodology assumes that the first copy of the first ½ of the metadata in Chip 0 and the first copy of the other ½ of the metadata in Chip 1 are faulty (e.g., the first copy of the metadata in both Chip 0 and Chip 1 are locally corrupted), and then accesses the second copy of the metadata in both Chip 0 and Chip 1. ECC is again used to determine if the metadata accessed is uncorrectable. If it is still uncorrectable, the controller may report that the metadata is not correctable. The sequence of assumptions (e.g., that Chip 0 is first assumed to be faulty) is merely for illustration purposes. The above-discussion with 2-chips is also for illustration purposes. The methodology may be used for greater than 2-chips, such as 4-chips.

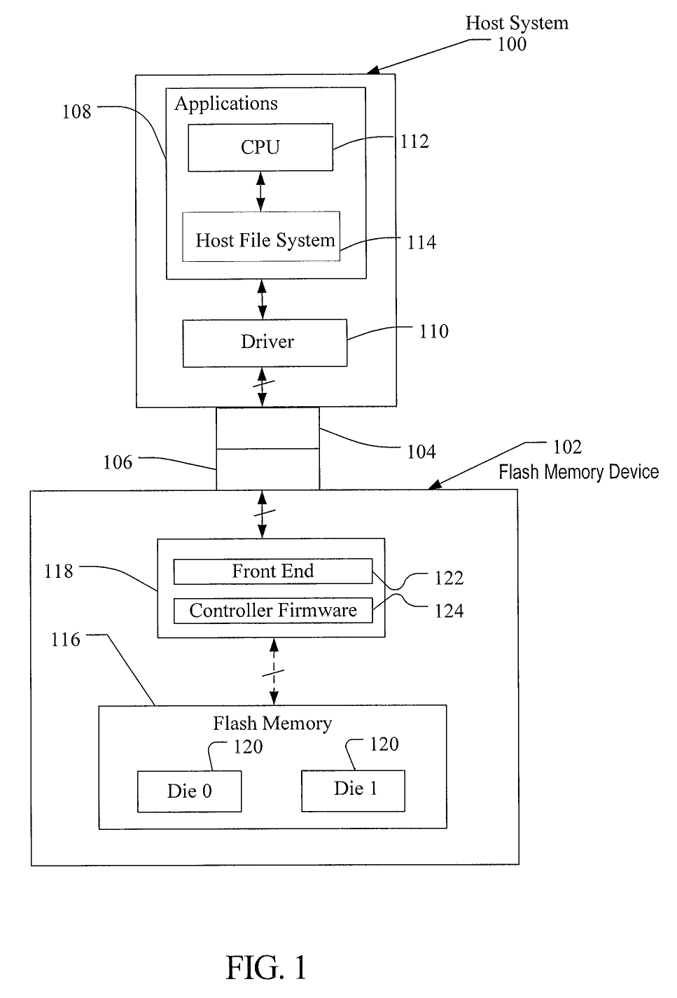

A flash memory device suitable for use in implementing metadata protection from flash memory failures is shown in FIG. 1. A host system 100 of FIG. 1 stores data into and retrieves data from a flash memory device 102. The memory device may be flash memory embedded within the host, such as in the form of a solid state disk (SSD) drive installed in a personal computer. Alternatively, the flash memory device 102 may be in the form of a card that is removably connected to the host through mating parts 104 and 106 of a mechanical and electrical connector as illustrated in FIG. 1. A flash memory configured for use as an internal or embedded SSD drive may look similar to the schematic of FIG. 1, with the primary difference being the location of the flash memory device 102 internal to the host. SSD drives may be in the form of discrete modules that are drop-in replacements for rotating magnetic disk drives.

The host system 100 of FIG. 1 may be viewed as having two major parts, insofar as the flash memory device 102 is concerned, made up of a combination of circuitry and software. They are an applications portion 108 and a driver portion 110 that interfaces with the flash memory device 102. In a PC, for example, the applications portion 108 can include a processor, such as CPU 112, running word processing, graphics, control or other popular application software, as well as the file system 114 for managing data on the host 100. In a camera, cellular telephone or other host system that is primarily dedicated to perform a single set of functions, the applications portion 108 includes the software that operates the camera to take and store pictures, the cellular telephone to make and receive calls, and the like.

The flash memory device 102 of FIG. 1 may include non-volatile memory, such as flash memory 116, and a system controller 118. The system controller 118 controls the flash memory 116 and communicates with the host 100 to which the flash memory device 102 is connected in order to pass data back and forth. The system controller 118 may convert between logical addresses of data used by the host 100 and physical addresses of the flash memory 116 during data programming and reading, and may include one or more methodologies for data recovery in the flash memory 116, such as disclosed below in FIGS. 6-8. As discussed in more detail below, the data recovered comprises metadata. In one embodiment, metadata is descriptive of the user data stored in the flash memory 116. For example, the metadata may include a map of LBAs to physical addresses of the flash memory 116. In this way, loss of the metadata may result in losing access to the user data stored in the flash memory 116.

The flash memory 116 may include any number of memory dies 120. FIG. 1 illustrates two memory die simply by way of illustration. Functionally, the system controller 118 may include a front end 122 that interfaces with the host system, and controller firmware 124 for coordinating operation of the memory 116.

The system controller 118 may be implemented on a single integrated circuit chip, such as an application specific integrated circuit (ASIC). Each die 120 in the flash memory 116 may contain an array of memory cells organized into multiple planes. Alternatively, the memory cell array of a memory bank may not be divided into planes.

The memory cells may be operated to store more than two detectable levels of charge in each charge storage element or region, thereby to store more than one bit of data in each. This configuration is referred to as multi-level cell (MLC) memory. Alternatively, the memory cells may be operated to store two levels of charge so that a single bit of data is stored in each cell. This is typically referred to as a binary or single level cell (SLC) memory. Both types of memory cells may be used in a memory, for example binary flash memory may be used for caching data and MLC memory may be used for longer term storage. The charge storage elements of the memory cells are most commonly conductive floating gates but may alternatively be non-conductive dielectric charge trapping material.

In implementations of MLC memory operated to store two bits of data in each memory cell, each memory cell is configured to store four levels of charge corresponding to values of “11,” “01,” “10,” and “00.” Each bit of the two bits of data may represent a page bit of a lower page or a page bit of an upper page, where the lower page and upper page span across a series of memory cells sharing a common word line. Typically, the less significant bit of the two bits of data represents a page bit of a lower page and the more significant bit of the two bits of data represents a page bit of an upper page.

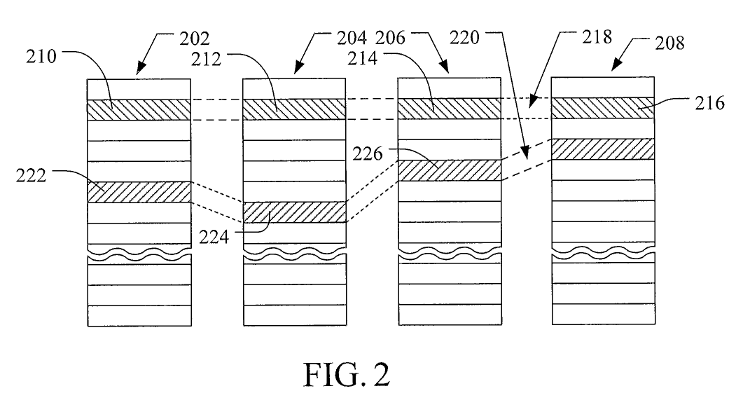

FIG. 2 conceptually illustrates an organization of a part of the flash memory 102, such as one bank in flash memory 102. Four planes 202-208 of memory cells may be on a single integrated memory cell chip, on two chips (such as two of the planes on each chip), on four separate chips, etc. The specific arrangement is not important to the discussion below. Of course, other numbers of planes, such as 1, 2, 8, 16 or more may exist in a system. The planes may be individually divided into blocks of memory cells by rectangles, such as blocks 210, 212, 214 and 216, located in respective planes 202-208. There may be hundreds or thousands of blocks in each plane.

The block of memory cells may be the unit of erase, the smallest number of memory cells that are physically erasable together. For increased parallelism, however, the blocks may be operated in larger metablock units. One block from each plane may be logically linked together to form a metablock. The four blocks 210-216 are shown to form one metablock 218. All of the cells within a metablock are typically erased together. The blocks used to form a metablock need not be restricted to the same relative locations within their respective planes, as is shown in a second metablock 220 made up of blocks 222-228. Although it is usually preferable to extend the metablocks across all of the planes, for high system performance, the memory device can be operated with the ability to dynamically form metablocks of any or all of one, two or three blocks in different planes. This allows the size of the metablock to be more closely matched with the amount of data available for storage in one programming operation.

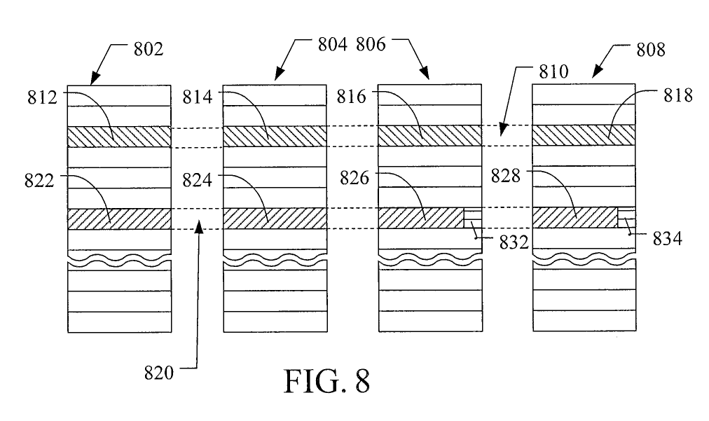

FIG. 8 illustrates an example of a programmable unit within a single metablock, spread over four planes 802-808. The smallest programmable unit within a single block is a page, and in this example metapage 810 is spread over four pages 812-818. Within metapage 820, there is a more detailed example of how data is laid out, including host system 100 accessible data in 822-828 and metadata in 832-834. The metadata is appended by the system controller 118 and is used for translating host logical addresses to physical addresses of the flash memory 116.

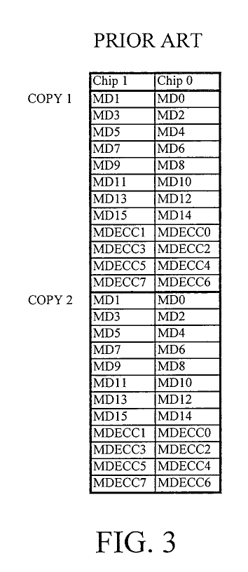

FIG. 3 illustrates a prior art listing of the copies for metadata striped over two chips. As shown in FIG. 3, if one of the chips completely fails, such as Chip 0, the metadata may not be recovered. Chip 1 in FIG. 3 includes a copy (COPY 2); however, COPY 2 is an exact copy of COPY 1 in Chip 1. In this way, if Chip 0 fails, the metadata may not be recoverable.

FIG. 4 illustrates an example listing of the copies for metadata stored in the two flash memory chips, with the copies being different in at least one aspect and with the sequence of reconstruction illustrated if Chip 0 fails. As discussed above, ECC protected metadata, which includes both the metadata and ECC data, may be stored across the multiple flash memory chips. As shown in FIG. 4, two copies of ECC protected metadata are written, striped over 2 physical NAND pages each with 8 bit interfaces. The first copy (COPY 1) of the metadata is written out in the following logical order:

metadata0=[md0, md1, md2, md3, . . . md30, md31, ecc0, ecc1, . . . ecc18, ecc19]

It is noted that all even bytes [md0, md2 . . . ecc0, ecc2 . . . ] are on physical chip 0, and all odd bytes [md1, md3 . . . ecc1, ecc3 . . . ] are on physical Chip 1. In an alternative embodiment, some, but not all, of the even bytes [md0, md2 . . . ecc0, ecc2 . . . ] are on physical chip 0, and some, but not all, of odd bytes [md1, md3 . . . ecc1, ecc3 . . . ] are on physical chip 1. In this alternative embodiment, the number of the even bytes is sufficient so that reconstruction with ECC is possible.

In one aspect, the second copy (COPY 2) of the ECC protected metadata is reordered as follows:

metadata1=[md1, md0, md3, md2, . . . md31, md30, ecc1, ecc0, . . . ecc19, ecc18]

Without consuming any additional space in the NAND page, there is still redundancy even if 1 of the 2 physical NAND pages returns uncorrectable data. For example, if physical chip 0 returns all incorrect data (identified as ‘X’), there is still a full copy of the ECC protected metadata on physical chip 1, as shown in the following:

metadata0=[X, md1, X, md3, . . . X, md31, X, ecc1, . . . X, ecc19]
metadata1=[X, md0, X, md2, . . . X, md30, X, ecc0, . . . X, ecc18]

If physical chip 1 returns all incorrect data (X), there is still a full copy of the ECC protected metadata on physical chip 0:

metadata0=[md0, X, md2, X, . . . md30, X, ecc0, X, . . . ecc18, X]
metadata1=[md1, X, md3, X, . . . md31, X, ecc1, X, . . . ecc19, X]

Recovery from uncorrectable metadata involves attempting to move either even/odd bytes from metadata1 into odd/even bytes of metadata 0, then attempting ECC correction. If ECC recovers the data, then recovery stops; if not, the alternate swap is attempted and ECC correction applied. This allows recovery in all cases except when the “good” physical flash page also has errors that exceed the ECC correction limit.

FIG. 5 illustrates another example listing of the copies for ECC protected metadata striped over two chips, with the copies being different in at least one aspect and with the sequence of recovery illustrated if one of the chips fails. COPY 1 of the ECC protected metadata stored on Chip 0 and Chip 1 are identical to that illustrated in FIG. 4. However, COPY 2 of the ECC protected metadata stored on Chip 0 and Chip 1 differs from that illustrated in FIG. 4. As shown in FIG. 5, COPY 2 stored on Chip 0 stores a combination of the ECC protected metadata from COPY 1 on both Chip 0 and Chip 1. In particular, COPY 2 stores at least a part of COPY 1 from both Chip 0 and from Chip 1. Thus, COPY 2 stores the following from COPY 1 on Chip 1: MD1; MD3, MD5; MD7; MD9; MD11; and MD13. COPY 2 also stores the following from COPY 1 on Chip 0: MD14. Likewise, COPY 2 stored on Chip 1 stores a combination of the metadata stored in COPY 1 on Chip 0 and on Chip 1.

FIG. 6 illustrates yet another example listing of the copies for ECC protected metadata striped over two chips, with the copies being different in at least one aspect and with the sequence of recovery illustrated if one of the chips fails. COPY 1 of the ECC protected metadata stored on Chip 0 and Chip 1 are identical to that illustrated in FIG. 4. However, COPY 2 of the ECC protected metadata stored on Chip 0 and Chip 1 differs from that illustrated in FIG. 4. As shown in FIG. 6, COPY 2 stored on Chip 0 stores less than all of the ECC protected metadata stored COPY 1 stored on Chip 1. As shown in FIG. 6, part of the metadata in COPY 2 is missing (i.e., the portions in memory for storage of the portion of the metadata in COPY 2 is blank). Alternatively, part of the ECC data may be missing. In still an alternate embodiment, the size of the memory space allocated to COPY 2 may be smaller than COPY 1 since COPY 2 stores less data. In the example of FIG. 6, the size of COPY 2 may be 2 bytes smaller since two bytes of metadata is not stored. The amount of ECC protected metadata stored in COPY 2 may still be sufficient for reconstruction with error correction coding.

Using the redundant copies as illustrated in FIGS. 4-6, the metadata is protected from a single NAND chip failure, allowing the controller to rebuild the correct logical to physical page mapping. Even if the user data is not redundant, this methodology recovery of the metadata, thereby allowing the LBA to physical mapping table rebuild process to complete; otherwise, the physical page would not be mapped and mapping table rebuild would fail. For example, the methodology enables the rebuilding of the LBA to physical mapping table.

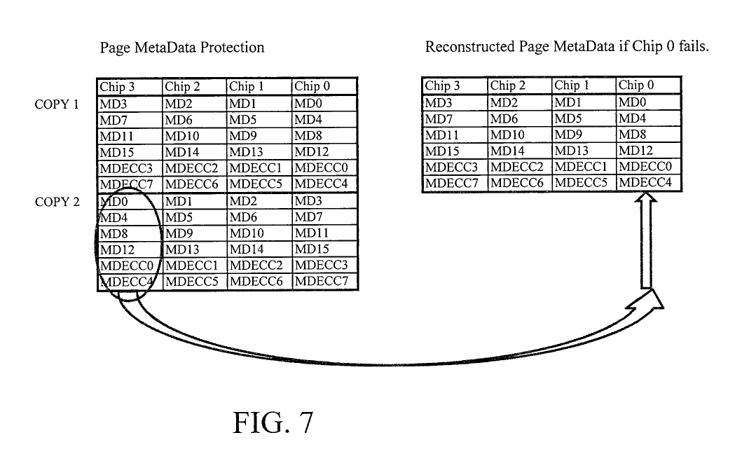

FIG. 7 illustrates an example listing of the copies for metadata striped over four chips, with the copies being different in at least one aspect and with the sequence of recovery illustrated if one of the chips fails. Similar to FIG. 4, FIG. 7 illustrates a first copy (COPY 1) and a second copy (COPY 2), with the second copy being different from the first copy. In FIG. 7, COPY 2 includes the metadata for Chip 0. In this way, if Chip 0 fails, COPY 2 may be used to reconstruct the metadata.

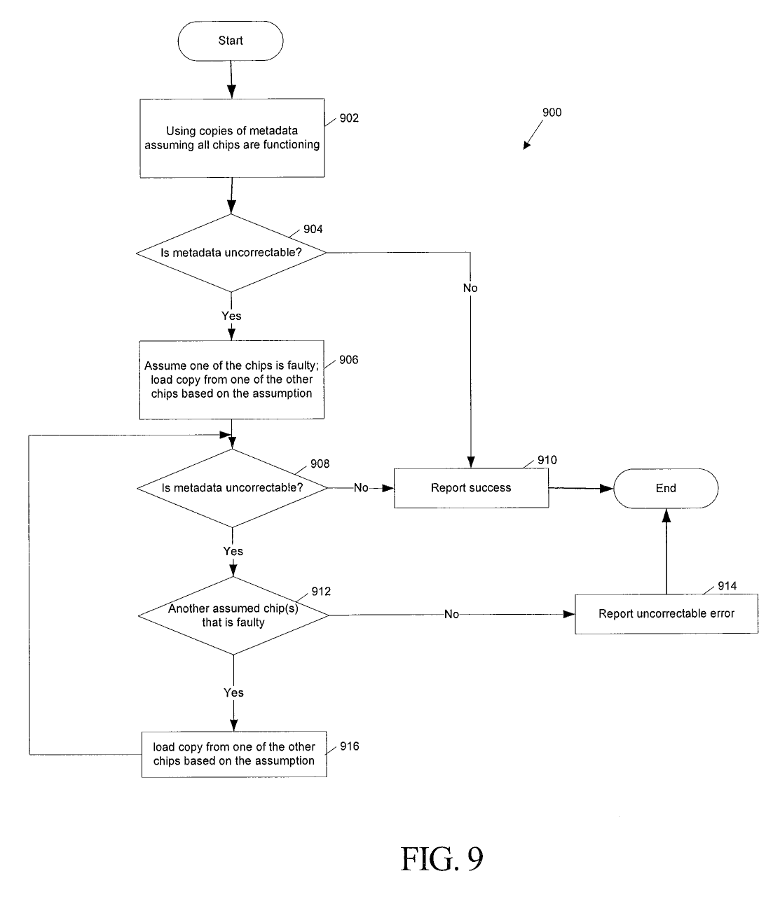

FIG. 9 is a flow chart 900 illustrating the steps by which to check the various copies of the metadata. At 902, the copies of the metadata are used assuming that all of the chips are properly functioning. In particular, the initial assumption is that none of the chips have failed. In the example depicted in FIG. 4, COPY 1 from both Chip 0 and Chip 1 are used. In the example depicted in FIG. 5, COPY 1 from Chip 0, Chip 1, Chip 2, and Chip 3 are used. At 904, ECC is used to determine whether the metadata is correctable or not. If the metadata is correctable, it is assumed that there is no fault or that any fault is correctable, so that, at 910, success is reported and the flow chart ends. If the metadata is uncorrectable, then at 906, it is assumed that one or more of the chips is faulty, and based on this assumption, copy (or copies) from other chip(s) are loaded. In the example depicted in FIG. 4, it may first be assumed that Chip 0 is bad. Given this assumption, COPY 2 from Chip 1 is loaded. This is depicted in FIG. 4. For a 4-chip example, it may be assumed that Chip 0 and Chip 1 are bad. Given this assumption, COPY 2 from Chip 2 and Chip 3 are loaded. Alternatively, for the 4-chip example, it may be assumed that only 1 chip is bad (such as Chip 0). Given this assumption, COPY 2 from Chip 3 is loaded.

At 908, ECC is again used to determine whether the accessed metadata is correctable or not. If the metadata is correctable, at 910, success is reported and the flow chart ends. Further, it may be reported which chips are believed to be in error. In the example above, Chip 0 is assumed to be faulty and COPY 2 from Chip 1 is loaded. If COPY 2 from Chip 1 proves to be correctable, it may then be determined that Chip 0 is in fact faulty, and this determination may be reported.

If the metadata is uncorrectable, at 912, it is determined whether there is another assumption of faulty chip(s) available. Thus, if the assumption proves to be incorrect, it is determined where there are other assumptions available to be investigated. For example, if Chip 0 was assumed to be faulty, and the assumption proved incorrect, it may then be assumed that Chip 1 is faulty. At 916, the copy (or copies) are loaded from one of the other chip(s) based on the assumption and the flow chart loops back to 908. If there are no other assumptions to test, at 914, an uncorrectable error may be reported and the flow chart ends.

The example of four chips depicted in FIG. 5 is more complicated than the example of two chips depicted in FIG. 4. After assuming and testing that all the chips are operating properly (using COPY 0 from Chip 0, Chip 1, Chip 2, and Chip 3), the recovery may assume that one or more chips are faulty. For example, the recovery may assume that Chip 0 and Chip 1 are both faulty and attempt correction. If the correction fails, the recovery may assume that Chip 2 and Chip 3 are faulty and attempt correction. This has the advantage that the system may recover from a single chip failure in at most 2 attempts. In addition, it may be possible to recover from some two-chip failures. Therefore, further retry attempts with different chip combinations may be performed. The following is an example of a list of assumed chip failures: [0, 1]; [2, 3]; [0, 2]; and [1, 3].

It is intended that the foregoing detailed description be understood as an illustration of selected forms that the invention can take and not as a definition of the invention. It is only the following claims, including all equivalents, which are intended to define the scope of this invention. Also, some of the following claims may state that a component is operative to perform a certain function or configured for a certain task. It should be noted that these are not restrictive limitations. It should also be noted that the acts recited in the claims can be performed in any order and not necessarily in the order in which they are recited.

What is claimed is:

1. A method of storing redundant copies of metadata in order to protect the metadata from flash memory device failures, the method comprising:
in a flash memory device with a controller and first and second flash memory partitions, user data being stored across the first and second flash memory partitions and metadata corresponding to the user data, the metadata including at least a first part and a second part:
storing in the first flash memory partition a first copy of the first part of the metadata;
storing in the second flash memory partition a first copy of the second part of the metadata; and
storing in the first flash memory partition a second copy of the second part of the metadata.

2. The method of claim 1, wherein the first flash memory partition comprises a first flash memory chip; and
wherein the second flash memory partition comprises a second flash memory chip.

3. The method of claim 2, further comprising storing in the second flash memory chip a second copy of the first part of the metadata.

4. The method of claim 3, wherein Error Correction Coding (ECC) protected metadata comprises the metadata and ECC data;
wherein the first copy stored in the first flash memory chip comprises a first part of the ECC protected metadata;
wherein the first copy stored in the second flash memory chip comprises a second part of the ECC protected metadata;
wherein the second copy stored in the first flash memory chip comprises the second part of the ECC protected metadata; and
wherein the second copy stored in the second flash memory chip comprises the first part of the ECC protected metadata.

5. The method of claim 4, further comprising:
determining whether the first copy in the first flash memory chip and the first copy in the second flash memory chip are correctable; and
if it is determined that the first copy in the first flash memory chip and the first copy in the second flash memory chip are not correctable, using at least one of the second copy in the first flash memory chip or the second copy in the second flash memory chip.

6. The method of claim 5, wherein using at least one of the second copy in the first flash memory chip or the second copy in the second flash memory chip comprises:
if it is determined that the first copy in the first flash memory chip and the first copy in the second flash memory chip are not correctable, determining whether the first copy and the second copy in the first flash memory chip are correctable; and
if it is determined that the first copy and the second copy in the first flash memory chip are not correctable, determining whether the first copy and the second copy in the second flash memory chip are correctable.

7. The method of claim 5, wherein using at least one of the second copy in the first flash memory chip or the second copy in the second flash memory chip comprises:
if it is determined that the first copy in the first flash memory chip and the first copy in the second flash memory chip are faulty, using the second copy in the first flash memory chip and the second copy in the second flash memory chip.

8. The method of claim 1, wherein the user data is stored across four or more flash memory chips;
wherein each of the four or more flash memory chips has stored therein a first copy of different parts of the metadata; and
wherein each of the four or more flash memory chips also has stored therein a second copy of the different parts of the metadata, the second copy being identical to the first copy stored on another of the four or more flash memory chips.

9. The method of claim 8, further comprising:
determining whether the first copies of the metadata of the four or more flash memory chips are correctable; and
if it is determined that the first copies of the metadata of the four or more chips are not correctable, assuming two flash memory chips are faulty and determining whether the second copies of the metadata for the assumed faulty flash memory chips and the first copies of a remainder of the flash memory chips are correctable.

10. A method of storing redundant copies of metadata in order to protect the metadata from flash memory device failures, the method comprising:
in a flash memory device with a controller and first and second flash memory partitions, user data being stored across the first and second flash memory partitions and metadata corresponding to the user data, the metadata including at least a first part and a second part:
storing in the first flash memory partition a first copy of the first part of the metadata;
storing in the second flash memory partition a first copy of the second part of the metadata; and
storing in the first flash memory partition a second copy of at least some of the second part of the metadata.

11. The method of claim 10, wherein the first flash memory partition comprises a first flash memory chip; and
wherein the second flash memory partition comprises a second flash memory chip.

12. The method of claim 11, further comprising storing in the second flash memory chip a second copy of at least some of the first part of the metadata.

13. The method of claim 12, wherein the second copy in the first flash memory chip includes less than all of the second part of the metadata; and
wherein the second copy in the second flash memory chip includes less than all of the first part of the metadata.

14. The method of claim 13, wherein Error Correction Coding (ECC) protected metadata comprises the metadata and ECC data;
wherein the first copy stored in the first flash memory chip comprises a first part of the ECC protected metadata;
wherein the first copy stored in the second flash memory chip comprises a second part of the ECC protected metadata;
wherein the second copy stored in the first flash memory chip comprises less than all of the second part of the ECC protected metadata; and
wherein the second copy stored in the second flash memory chip comprises less than all of the first part of the ECC protected metadata.

15. A memory device configured to store redundant copies of metadata in order to protect the metadata from memory device failures, the metadata corresponding to the user data and including at least a first part and a second part, the memory device comprising:
a memory including a first flash memory partition and a second flash memory partition; and
a controller in communication with the memory, the controller configured to:
store user data across the first and second flash memory partitions;
store in the first flash memory partition a first copy of the first part of the metadata;
store in the second flash memory partition a first copy of the second part of the metadata; and
store in the first flash memory partition a second copy of the second part of the metadata.

16. The memory device of claim 15, wherein the first flash memory partition comprises a first flash memory chip; and
wherein the second flash memory partition comprises a second flash memory chip.

17. The memory device of claim 16, wherein the controller is further configured to store in the second flash memory chip a second copy of the first part of the metadata.

18. The memory device of claim 17, wherein Error Correction Coding (ECC) protected metadata comprises the metadata and ECC data;
wherein the first copy stored in the first flash memory chip comprises a first part of the ECC protected metadata;
wherein the first copy stored in the second flash memory chip comprises a second part of the ECC protected metadata;
wherein the second copy stored in the first flash memory chip comprises the second part of the ECC protected metadata; and
wherein the second copy stored in the second flash memory chip comprises the first part of the ECC protected metadata.

19. The memory device of claim 18, the controller is further configured to:
determine whether the first copy in the first flash memory chip and the first copy in the second flash memory chip are correctable; and
if it is determined that the first copy in the first flash memory chip and the first copy in the second flash memory chip are not correctable, use at least one of the second copy in the first flash memory chip or the second copy in the second flash memory chip.

20. The memory device of claim 19, wherein the controller is configured to use at least one of the second copy in the first flash memory chip or the second copy in the second flash memory chip by:
if it is determined that the first copy in the first flash memory chip and the first copy in the second flash memory chip are not correctable, determine whether the first copy and the second copy in the first flash memory chip are correctable; and
if it is determined that the first copy and the second copy in the first flash memory chip are not correctable, determine whether the first copy and the second copy in the second flash memory chip are correctable.

21. The memory device of claim 19, wherein the controller is configured to use at least one of the second copy in the first flash memory chip or the second copy in the second flash memory chip by:
if it is determined that the first copy in the first flash memory chip and the first copy in the second flash memory chip are faulty, use the second copy in the first flash memory chip and the second copy in the second flash memory chip.

22. The memory device of claim 15, wherein the user data is stored across four or more flash memory chips;
wherein each of the four or more flash memory chips has stored therein a first copy of different parts of the metadata; and
wherein each of the four or more flash memory chips also has stored therein a second copy of the different parts of the metadata, the second copy being identical to the first copy stored on another of the four or more flash memory chips.

23. The memory device of claim 22, the controller is further configured to:
determine whether the first copies of the metadata of the four or more flash memory chips are correctable; and
if it is determined that the first copies of the metadata of the four or more chips are not correctable, assume two flash memory chips are faulty and determine whether the second copies of the metadata for the assumed faulty flash memory chips and the first copies of a remainder of the flash memory chips are correctable.

24. A memory device configured to store redundant copies of metadata in order to protect the metadata from memory device failures, the metadata corresponding to the user data and including at least a first part and a second part, the memory device comprising:
a memory including a first flash memory partition and a second flash memory partition; and
a controller in communication with the memory, the controller configured to:
store user data across the first and second flash memory partitions;
store in the first flash memory partition a first copy of the first part of the metadata;
store in the second flash memory partition a first copy of the second part of the metadata; and
store in the first flash memory partition a second copy of at least some of the second part of the metadata.

25. The memory device of claim 24, wherein the first flash memory partition comprises a first flash memory chip; and
wherein the second flash memory partition comprises a second flash memory chip.

26. The memory device of claim 25, wherein the controller is further configured to store in the second flash memory chip a second copy of at least some of the first part of the metadata.

27. The memory device of claim 26, wherein the second copy in the first flash memory chip includes less than all of the second part of the metadata; and
wherein the second copy in the second flash memory chip includes less than all of the first part of the metadata.
